(19) United States
(12) Patent Application Publication
(10) Pub. No.: US 2024/0353254 A1
(43) Pub. Date: Oct. 24, 2024

(54) IDENTIFYING EVENTS IN DISTRIBUTED ACOUSTIC SENSING DATA

(71) Applicant: VIAVI SOLUTIONS INC., Chandler, AZ (US)

(72) Inventor: Matt MCDONALD, Calgary (CA)

(73) Assignee: VIAVI SOLUTIONS INC., Chandler, AZ (US)

(21) Appl. No.: 18/685,767

(22) PCT Filed: Nov. 10, 2022
(86) PCT No.: PCT/GB2022/052845

§ 371 Date: Feb. 22, 2024

(30) Foreign Application Priority Data
Nov. 19, 2021 (GB) 2116736.6

(51) Int. Cl. G01H 9/00; G06N 3/08

(52) U.S. Cl. CPC G01H 9/004; G06N 3/08

(57) ABSTRACT

There is disclosed a method of training one or more event models for use in identifying events of interest proximal to the sensing optical fibre, from a distributing acoustic sensing signal representing acoustic vibration at positions along a sensing optical fibre. A distributed acoustic sensor is provided and arranged to form a distributed acoustic sensing signal. A calibration defining the mapping between the distributed acoustic sensing signal and positions along the sensing optical fibre is obtained. Events of interest of one or more different event categories are implemented at measured positions along the sensing optical fibre. The distributed sensing signal is formed during the implemented events of interest. For each event of interest, one or more training data subsets of the distributed acoustic sensing signal are defined. These training data sets are defined to be contemporary with the implemented event and spatially positioned within the signal, using the measured positions and the calibration, so as to include the implemented event. The training data subsets are then used to train one or more event models to detect the events of interest.

The present disclosure relates to methods and apparatus for identifying events of interest in distributed acoustic sensing (DAS) data, for example events reflecting footsteps, vehicle movements, or digging, proximal to a sensing optical fibre buried in the ground along a locus such as a security perimeter or otherwise disposed through an environment.

### INTRODUCTION

Distributed acoustic sensing is a technique in which probe light backscattered within the native material of a sensing optical fibre extending through an environment, typically using coherent Rayleigh backscatter, is used to detect acoustic vibration at the sensing optical fibre. Distributed acoustic sensing may be used to detect a wide variety of different kinds of event of interest in such acoustic signals, but constructing automatic analysis systems to reliably detect and identify such events of interest may be onerous, for example requiring extensive user analysis to characterize such events in the distributed acoustic sensing signal, and to construct suitable filters or models to then identify the events of interest with reasonably accuracy and minimal false positives.

More generally, it would be desirable to address problems and limitations of the related prior art.

### SUMMARY OF THE INVENTION

The invention relates to the automatic generation of labelled distributed acoustic sensing signal data, and in particular to automatically defining training data subsets of such data, for the purposes of training machine learning models to identify events of interest in similar distributed acoustic sensing signals.

The trajectory of a sensing optical fibre through an environment may be calibrated to a reference frame system, for example using the global positioning system (GPS). Events of interest may then be implemented at a variety of positions at or proximal to the sensing optical fibre, with those positions being measurable using the same reference frame system. Apparatus for defining training data subsets within distributed acoustic sensing signals formed using the sensing optical fibre may then be calibrated to the same reference frame system, so that the training data subsets may be more accurately labelled or defined within the distributed acoustic sensing signal data.

More specifically, a calibration defining a mapping between the distributed acoustic sensing signal itself, and geospatial positions along the sensing optical fibre from which the signal is derived, can be obtained or determined and then used to assist in the formation of training data subsets of a distributed acoustic sensing signal. Such an arrangement enables training data subsets to be formed automatically from a distributed acoustic sensing signal if the geospatial position of an event of interest implemented at or near the sensing optical fibre is separately determined for example by an event position locator which is collocated with the agent performing the event of interest. These automatically generated training data subsets can then be used, without human intervention or correction, to train automated machine learning models for subsequent detection of such events in a similar distributed acoustic sensing signal.

The inventors note that labelling of distributed acoustic sensing data for forming training data subsets for machine learning models could be performed either manually, where a human interacts with the sensing data in a graphical user interface to generate labels and subsets, or in a semi-automated, recursive manner, where a machine learning model is trained on a manually labelled dataset and then used to generated new labels or subsets for previously unseen data. However, the semi-automated generated labels will still typically contain frequent errors, and will then need to be corrected by human intervention before being suitable for use for event model training. Both the manual and semi-automated methods are slow, cumbersome, and prone to user error, and make generating sufficient volumes of training data difficult. The present invention permits such human intervention to be avoided while maintaining or even increasing accuracy of data labelling, thereby leading to more efficient generation of accurate training data subsets, and allowing much larger sets of such training data to be accurately generated

More particularly, the invention provides a method of training one or more event models, for example machine learning event models such as deep neural networks, for use in identifying, from a distributed acoustic sensing signal representing acoustic vibration at positions along a sensing optical fibre, events of interest proximal to the sensing optical fibre, the method comprising: providing a distributed acoustic sensor arranged to form a distributed acoustic sensing signal; determining or obtaining a calibration defining a mapping between the distributed acoustic sensing signal and positions along the sensing optical fibre; implementing events of interest of one or more different event categories, at measured positions along the sensing optical fibre: forming the distributed acoustic sensing signal during the implemented events of interest; for each implemented event of interest, defining one or more training data subsets of the distributed acoustic sensing signal which are contemporary with the implemented event, and spatially positioned within the signal using the measured positions and the calibration so to include the implemented event; and using the training data subsets to train one or more event models to detect the events of interest.

Although the actual implementation of events of interest may be by a human agent or vehicle typically following the trajectory of the sensing optical fibre through the environment, the method permits the defining of the one or more training data subsets to be implemented automatically and without human intervention, because use of the calibration mapping permits the training data subsets to be more reliably positioned spatially relative to, for example to be centered on, the implemented events of interest.

One or more different categories of event of interest may be detected by the event models. Typical such event categories may comprise one or more of: a person walking, manual digging, mechanical digging, and a vehicle driving. A single event model, or multiple event models may then be trained to separately identify, or to distinguish between, events of two or more event categories.

The calibration may be obtained by using a calibration vibration source to generate calibration acoustic signals sequentially at multiple different locations along the sensing optical fibre while using the distributed acoustic sensor to form a distributed acoustic sensing signal; detecting the calibration acoustic signals within the distributed acoustic sensing signal; separately detecting locations of the calibration vibration source as the calibration acoustic signals are being generated; and using the detected calibration acoustic signals with the separately detected locations to obtain the calibration. For example, a human agent with a vibration source may walk a length of the sensing optical fibre to allow the calibration to be obtained.

Separately detecting locations of the calibration vibration source as the calibration acoustic signals are being generated may then comprise using a calibration position detector collocated with the calibration vibration source to detect the locations. For example, the calibration position detector may comprise a device carried by a human agent or vehicle which also carries the calibration vibration source. The calibration position detector might typically be a satellite based navigation system detector such as a GPS receiver, or could be implemented in other ways as described in more detail later in this document.

Implementing events of interest of one or more different event categories, at measured positions along the sensing optical fibre, may comprise using one or more agents to implement the events of interest, and measuring the positions of the implemented events using an event position detector collocated with each such agent. Similar to the generation of calibration vibration signals, the agent could be a human agent walking along the path of the sensing optical fibre, or a vehicle following a similar path. The positions of along the sensing optical fibre are then typically measured at the same times as the actual implementation of the associated events of interest.

Similar to the implementation of the calibration position detectors, the event position detectors may comprise satellite based navigation system detectors such as a GPS receivers, or could be implemented in other ways as discussed below. It may be advantageous for the calibration position detectors and event position detectors to be implemented in the same way, or using the same reference frame or technology, so as to better ensure that the obtained calibration mapping is of optimum relevance to the measured positions of the implemented events.

The described methods may then further comprise receiving a distributed acoustic sensing signal from the same or a different distributed acoustic sensor or sensing optical fibre, and detecting one or more events of interest using the one or more trained event models.

The invention also provides corresponding apparatus for training one or more event models such as machine learning models, for use in identifying, from a distributed acoustic sensing signal representing acoustic vibration at positions along a sensing optical fibre, events of interest proximal to the sensing optical fibre. Such apparatus may comprise one or more of: a geospatial calibration unit arranged to obtain a calibration which defines a mapping between the distributed acoustic sensing signal and positions along the sensing optical fibre; a training data segmentor arranged to receive the distributed acoustic sensing signal formed during implementation of events of interest of one or more different event categories, at measured positions along the sensing optical fibre, and for each implemented event of interest, to define one or more training data subsets of the distributed acoustic sensing signal which are contemporary with the implemented event, and which are spatially positioned within the signal using the measured positions and the calibration so to include the implemented event; and a model training unit arranged to use the training data subsets to train one or more event models to detect the events of interest.

The apparatus may further comprise a calibration vibration source for generating calibration acoustic signals sequentially at multiple different locations along the sensing optical fibre, and a calibration position detector collocated with the calibration vibration source for separately detecting locations of the calibration vibration source as it generates calibration acoustic signals. The calibration vibration source could be carried by a human agent or a vehicle for example, and could simply provide periodic impulses to the environment, or a calibration acoustic signal more particularly adapted for automatic recognition by the geospatial calibration unit, for example by using one more specific acoustic frequencies or frequency profile.

The geospatial calibration unit may then be arranged to obtain the calibration by detecting the calibration acoustic signals in the distributed acoustic sensing signal, and combining the detected acoustic calibration signals with the detected locations of the calibration vibration source. In particular, since geospatial calibration unit may automatically seek in the distributed acoustic sensing signal the calibration acoustic signal, through knowledge of the timing of the calibration acoustic signal, and optionally the approximate location and optionally a frequency characteristic or form of the acoustic signal. The geospatial calibration unit can then associate the location in the distributed acoustic sensing signal of the calibration acoustic signal with the separately detected location. Multiple such associations can then be used to define the calibration mapping along the sensing optical fibre, either as a set of discrete associations, or one or more discrete or continuous mapping functions.

The apparatus may further comprise one or more event position detectors collocated with one or more agents implementing the events of interest, wherein the positions of the implemented events of interest are measured using the one or more event position detectors. The event position detectors could for example be carried by a human agent or a vehicle agent implementing the events of interest.

One or both of the calibration position detectors and the event position detectors may be satellite based navigation system detectors such as a GPS receivers. Aspects of the above methods and apparatus may be implemented on one or more suitable computer systems using suitable computer program code. Such computer systems may typically comprise one or more CPUs, computer memory for storing programs and data for carrying out the methods and apparatus aspects, and suitable input and output capabilities. In particular, the geospatial calibration unit, the training data segmentor, and the model training unit mentioned above and associated method functions may be implemented using suitable computer program software in this way.

To this end, the invention also provides one or more computer readable media carrying computer program code arranged such that, when executed on one or more suitable computer systems, aspects of the above methods and apparatus are put into effect. Such computer program code may, for example, be arranged to train one or more event models such as machine learning models, for use in identifying, from a distributed acoustic sensing signal representing acoustic vibration at positions along a sensing optical fibre, events of interest proximal to the sensing optical fibre, the computer program code being arranged to: determine or obtain a calibration which defines a mapping between the distributed acoustic sensing signal and positions along the sensing optical fibre; receive the distributed acoustic sensing signal formed during implementation of events of interest of one or more different event categories, and measured positions of the implemented events of interest along the sensing optical fibre, and for each implemented event of interest, to define one or more training data subsets of the distributed acoustic sensing signal which are contemporary with the implemented event, and which are spatially positioned within the signal using the measured positions and the calibration so to include the implemented event; and use the training data subsets to train one or more event models to detect the events of interest.

Note that although the invention is described mainly within the context of distributed acoustic sensing using an essentially one dimensional sensing optical fibre following a path through an environment, it may also be implemented using other sensing technologies for example using a sensing optical fibre comprising an array of Bragg gratings, using an array of discrete microphone devices or other acoustic sensors, and in other ways, where such arrays need not comprise only a one dimensional array but can potentially provide a network or array of acoustic detection locations which is one, two or three dimensional in nature.

To this end, the invention also provides a method of training one or more event models for use in identifying, from an acoustic sensing signal representing acoustic vibration at positions within an array, events of interest proximal to the array, the method comprising: providing an acoustic sensor arranged to form the acoustic sensing signal: obtaining a calibration defining a mapping between the acoustic sensing signal and positions within the array; implementing events of interest of one or more different event categories, at measured positions within the array: forming the acoustic sensing signal during the implemented events of interest; for each implemented event of interest, defining one or more training data subsets of the acoustic sensing signal which are contemporary with the implemented event, and spatially positioned within the signal using the measured positions and the calibration so as to include the implemented event; and using the training data subsets to train one or more event models to detect the events of interest.

Although the invention and embodiments are largely described in terms of detected acoustic vibration using distributed acoustic sensors, and in terms of processing and detecting events in such acoustic vibration signals, the invention and embodiments may more generally relate to use of one or more distributed optical fibre sensors to obtain and use physical disturbance or vibration signals in order to detect the described events.

To this end, the invention also provides a method of training one or more event models, for example machine learning event models such as deep neural networks, for use in identifying, from a distributed optical fibre sensor signal representing disturbance at positions along a sensing optical fibre, events of interest proximal to the sensing optical fibre, the method comprising: providing a distributed optical fibre sensor arranged to form a distributed sensing signal; determining or obtaining a calibration defining a mapping between the distributed sensing signal and positions along the sensing optical fibre; implementing events of interest of one or more different event categories, at measured positions along the sensing optical fibre; forming the distributed sensing signal during the implemented events of interest; for each implemented event of interest, defining one or more training data subsets of the distributed sensing signal which are contemporary with the implemented event, and spatially positioned within the signal using the measured positions and the calibration so to include the implemented event; and using the training data subsets to train one or more event models to detect the events of interest.

The invention similarly provides corresponding apparatus for training one or more event models such as machine learning models, for use in identifying, from a distributed sensing signal representing disturbance at positions along a sensing optical fibre, events of interest proximal to the sensing optical fibre.

### BRIEF SUMMARY OF THE DRAWINGS

Embodiments of the invention will now be described, by way of example only, with reference to the accompanying drawings of which:

FIG. 1 illustrates schematically an interrogator arranged to form a distributed acoustic sensing signal by interrogation of a sensing optical fibre, and an event monitor arranged to detect one or more events of interest occurring proximally to the sensing optical fibre using one or more event models operating within an event monitor;

FIG. 2 illustrates a calibration which maps between data within a distributed acoustic sensing signal and positions along a sensing optical fibre;

FIG. 3 shows how the calibration of FIG. 2 may be determined and how training data subsets may then be delineated within a distributed acoustic sensing signal for training one or more machine learning event models;

FIGS. 4a-4d show various ways in which training data subsets may be defined with a distributed acoustic sensing signal; and

FIG. 5 illustrates a process of training even models using the training data subsets defined as shown in FIGS. 3 and 4a-4d.

### DETAILED DESCRIPTION OF EMBODIMENTS

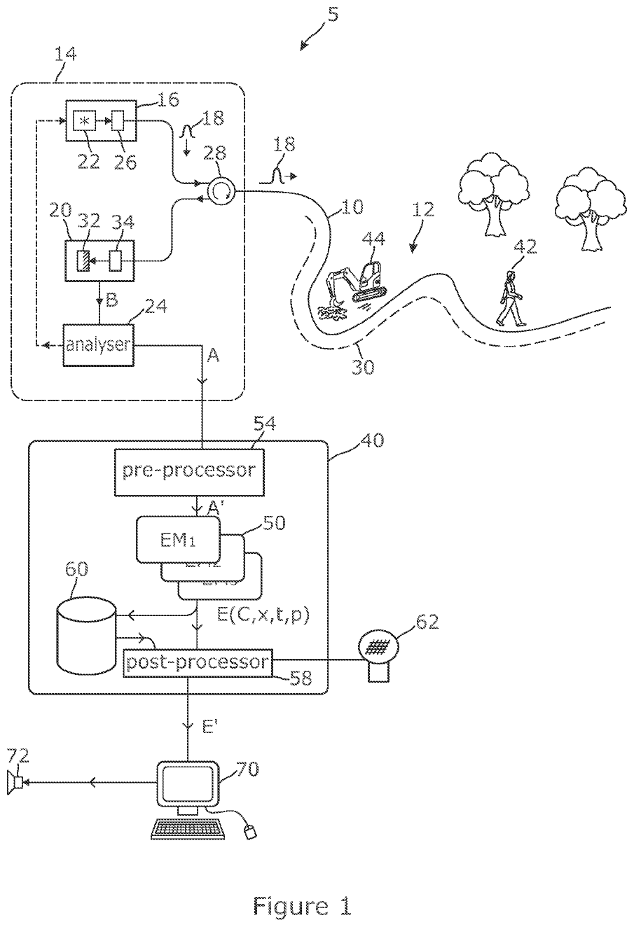

Referring to FIG. 1 there is illustrated a distributed acoustic sensor 5. The sensor comprises a sensing optical fibre 10 which follows a path 30 through an environment 12. A typical such environment might be around the perimeter of a security compound or building, along a railway or road, the area around pipeline, or through an engineering structure such as a building or bridge. The sensing optical fibre 10 may for example be buried in the ground or in a roadway, fastened to a fence, pipeline, or other engineered structure, embedded in the material of an engineering structure, and so forth. Generally speaking, the sensing optical fibre 10 should be arranged so as to be sufficiently exposed to acoustic vibrations generated by events of interest which occur in the vicinity of, or proximal to, the sensing optical fibre, for those vibrations to be readily detected by the distributed acoustic sensor 5. Such events of interest may be or correspond to any of people or animals walking near the sensing optical fibre, or one or more vehicles following or passing near the fibre for example along a roadway or track, including railway vehicles passing along a railway track. Events may also be or correspond to the generation of acoustic vibrations due to defects in such vehicles or due to defects in such a roadway or track, for example the passing of a railway truck with a defective wheel or axle. Events may also be or correspond to activities such as manual digging for example with a pick or shovel, mechanical digging for example with an excavator machine, disturbances at a nearby fence such as a person climbing or cutting or digging at the fence. Events may also be or correspond to rock, earth, trees, or other debris falling near the fibre for example in the case of a landslip or tree fall. Events may also be or correspond to fluid leaks from a nearby pipeline such as leaks of a gas or air. Events may also be or correspond to tampering with the sensing optical fibre in some way, for example by an intruder wishing to disable or compromise the acoustic sensor 5 and so forth.

The sensing of acoustic vibration may be achieved in embodiments of the invention using various techniques known in the prior art. Some such techniques are described for example in WO2016/012760, WO2017/125717, WO2019/224511, and WO2012/063066, each of which is hereby incorporated by reference for these and all other purposes, as well as being described elsewhere in the prior art.

In the arrangement of FIG. 1, an interrogator unit 14 of the sensor 5 includes a probe light source 16 for generating probe light pulses 18 of suitable timings, shapes and wavelengths, an optical detector 20 for detecting probe light resulting from the probe light pulses being backscattered within the sensing optical fibre 10, and an analyzer 24 for processing data representing properties of the backscattered and detected light which have been received at the optical detector 20. The probe light source 16 forms probe light pulses 18, each pulse having an optical wavelength, and contains one or more laser sources 22 to generate the probe light pulses 18. The probe light pulses may be conditioned in the probe light source by one or more source optical conditioning components 26. The probe light pulses are forwarded to an optical circulator 28 and from there on to the sensing optical fibre 10 which is disposed along the path 30 through the environment 12.

Probe light which has been Rayleigh backscattered within the sensing optical fibre 10 is received back at the circulator 28 which passes the collected light on to the optical detector 20, which comprises one or more optical detector elements 32. Such detector elements may comprise, for example, one or more suitable photodiodes. The backscattered light may be conditioned in the detector using one or more detector optical conditioning components 34. The detector 20 then passes a detected interference signal B corresponding to the detected backscattered probe light to the analyzer 24.

The analyzer 24 is arranged to process the detected interference signal B to generate and output a distributed acoustic sensing (DAS) signal A representing acoustic vibration as a function of position and time along the sensing optical fibre 10, and therefore also as a function of position and time along the path 30 of the sensing optical fibre 10 through the environment 12.

The sensor can be used to interrogate multiple sensing optical fibres 10 in parallel or in other configurations, for example with each such sensing optical fibre being disposed along a different path 30 through the environment 12, and/or in two directions around a loop of sensing fibre in order to provide redundancy or for other purposes, using probe light pulses of different wavelengths. Suitable such techniques are described in WO2012/076873, which is hereby incorporated by reference for all purposes. Various other arrangements and configurations of the sensor may be employed as will be familiar to the person skilled in the art.

The sensor may be operated using phase-sensitive optical time domain reflectometry (PS-OTDR) in which probe light pulses are used which are each sufficiently coherent that the detected backscatter signal contains or is dominated by self-interference between different parts of the same pulse. Such techniques which may be used in implementations of the present invention are described in WO2006/048647, WO2008/056143 and WO2012/063066 which are hereby incorporated by reference for implementation of the described PS-OTDR and for all other purposes. The resulting coherent Rayleigh backscatter leads to a temporal speckle pattern of interference fringes at the detector, which leads to the detector outputting a coherent Rayleigh backscatter interference signal B. This signal from the detector then represents, for each probe light pulse, a time series of intensity of the detected coherent Rayleigh backscatter interference. Typical lengths of the probe light pulses may be about 50 ns, to provide a spatial resolution along the sensing optical fibre of about 5 m, sufficient to detect the position or movement of individual people or vehicles from the DAS signal A, although other pulse lengths for example in the range 10 ns-200 ns could be used.

In order to sense the DAS signal as a function of time for a particular position along the sensing optical fibre, the temporal development of the interference signal, for a particular round trip time delay for travel of a probe light pulse which corresponds to that position, is followed over a series of probe light pulses. The round trip time to the end and back to the detector 20 for a 1000 meter long sensing fibre is about 10 microseconds, so that a pulse repeat rate of up to about 100 KHz can easily be used if required, although much lower pulse rates may be used, as long as the resulting DAS signal contains sufficient frequency range to adequately detect the events of interest which are discussed in more detail below.

The form of the coherent Rayleigh backscatter or other interference signal B arising from a single probe light pulse arises partly from refractive index variations along the sensing optical fibre. Such refractive index variations will be partly due to inherent variations arising from manufacture and installation of the fibre. However, the refractive index at any particular location will also vary over time due to environmental effects, in particular local changes in strain imposed on the optical fibre by acoustic vibration coupled into the material of the fibre or into an associated mounting or cable structure. The DAS signal A can then be derived from the interference signal in various ways for example by direct detection techniques such as comparison of the interference signal at a particular location from frame to frame (for example see U.S. Pat. No. 7,946,341), or by more direct measurement of interference phase changes at each location for example by counting interference fringes passing over time at each such location. In some implementations, coherent detection techniques may be used, such as those described in Lu et al., Journal of Lightwave Technology, Vol. 28, 22, 2010, in which probe light backscattered within the sensing optical fibre 10 is mixed with light from a local oscillator (typically from the same laser source as that used to generate the light directed into the sensing optical fibre), and phase of the mixed light is measured to determine phase changes and therefore the DAS signal at various locations along the fibre.

The DAS signal A is passed from the interrogator 14 to an event monitor 40 which functions to automatically identify, from the DAS signal, events of interest which occur proximally to the sensing optical fibre. Such events may include for example one or more people walking 42, manual digging, mechanical digging 44, a vehicle driving, and so forth as already mentioned above. To this end, the event monitor 40 comprises one or more event models 50 which have been trained, as discussed in more detail below, to automatically identify the events of interest. Typically the event models may be machine learning models, for example implemented as deep neural networks or in other ways.

Typically, the one or more event models 50 will be trained to identify events of interest in each of a plurality of categories C, for example where people walking is a first such category C=1, manual digging is a second such category C=2, mechanical digging is a third such category C=3, and a vehicle driving is a fourth such category C=4. However, the event models 50 could instead be arranged to identify events in a just single category. for example with that category combining all events of interest such as digging in general, or movement of people in general.

To this end, the event models 50 may be implemented as a single event model, or as multiple event models. If a single event model is used this could detect just a single category of event of interest, or could distinguish between multiple such categories and assign a best fit category to a particular event. If multiple even models are used, each event model could identify events of each of plural categories, or of just one category.

Output from the event models then may be represented as a collection or stream of event records each as E (C, x, t, p). where C is the category of the event, x is a position or range of positions of the event along the path 30 of the sensing optical fibre, tis a time or range of times of the event, and p is a level of certainty that the detection or categorization is correct.

Prior to the event models 50 being used to identify events of interest in the DAS signal A, the DAS signal may be processed in various ways by pre-processor 54 to provide processed DAS signal A′ for use by the event models. For example, the event models may operate most effectively if presented with a block of the DAS signal data which is of a suitable size in terms of the spatial and temporal extent which it represents, and the pre-processor 54 may to this end provide blocks of the DAS signal data to the event models which are of an appropriate size. For example, for detecting a person walking, a suitable signal block size could be around 20 meters in length and 10 seconds in duration, sufficient to capture several footsteps. For detecting mechanical digging the optical block size might be shorter in length for example only 10 meters, but longer in duration for example around 60 seconds.

The pre-processor 54 may also or instead carry out one or more transformations of the DAS signal to make it easier for the event models to identify events of interest such as applying smoothing, edge detection, contrast enhancement or other filters in the space and/or time dimensions of the acoustic data. The event models may also or instead be trained to operate on DAS signal data which has been transformed in some way. for example to operate the DAS signal transformed into an acoustic frequency spectral space, for example by use one or more Fourier transforms, and the pre-processor 54 may therefore be arranged to carry out any such transformations on the DAS signal A for passing to the event models as signal A′.

The event record or other output E of the event models may then be passed to a post-processor 58 for consolidation or other handling of the detected events. For example the post-processor 58 may combine or rationalize data relating to multiple identified events in various ways such as consolidating a series of events categorized as “walking” into a single more extended event where it appears these identify a longer trajectory of an individual person walking. Such consolidation of separately detected events may be implemented for example by determining a physically realistic trajectory along which the multiple events are detected and therefore appear to arise from the same person or vehicle, or using a Kalman filter or similar arrangement to achieve a similar effect. Similarly, multiple events of different types which appear to overlap in space and time may be reconciled for example walking or vehicle movement events interrupted by pauses within which digging events are detected.

The event model output E may also be stored at the event monitor 40 or elsewhere at a data store 60. This may enable the post-processor 58 to better establish the relationships between a series of events identified over time and/or space such as a series of walking events. The post processor 58 may also analyze the output of the event models 50 to determine if one or more alarms 62 should be activated, for example if the event model output indicates that some undesirable activity is occurring.

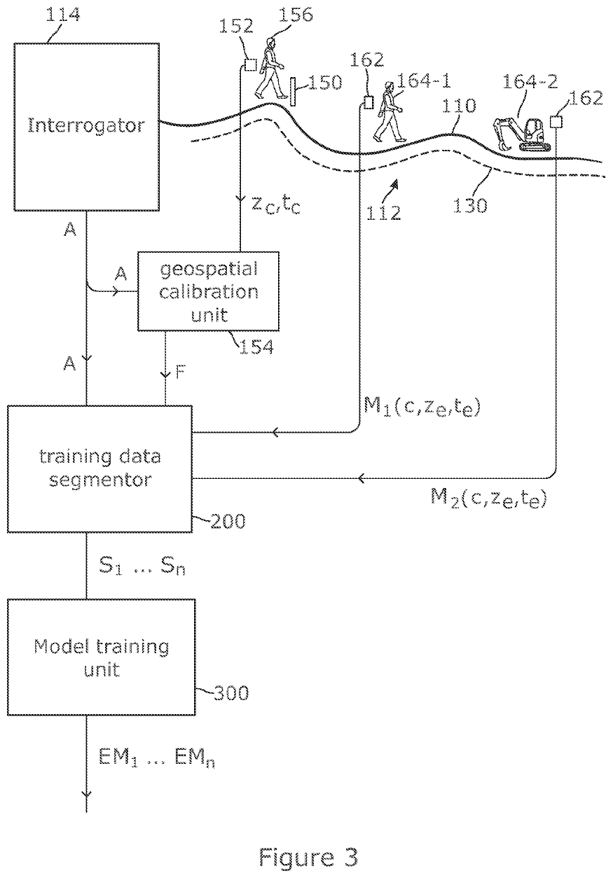

The output of the event models E or E′ may also be passed to one or more external computer systems 70 such as remote servers, personal computers, mobile devices, or monitoring stations, where various combinations of the acoustic vibration signal (processed as desired), detected events, and other related data may be displayed, and where one or more alarms 72 may be activated for example if the event model output indicates undesirable activity. Such alarms could be audible, visible (including for example a flag displayed within a graphical user interface), etc.

Whereas FIG. 1 illustrates how a DAS signal A derived from interrogation of the sensing optical fibre 10 is used to detect events of interest near to the sensing optical fibre using one or more event models 50 following operational deployment of the sensor 5, FIG. 3 illustrates how a DAS signal A may be processed by a training data segmentor 200 to provide suitable subsets of the signal data for use by an event model trainer 300 to train such event models 50 for subsequent use in just such an operational deployment.

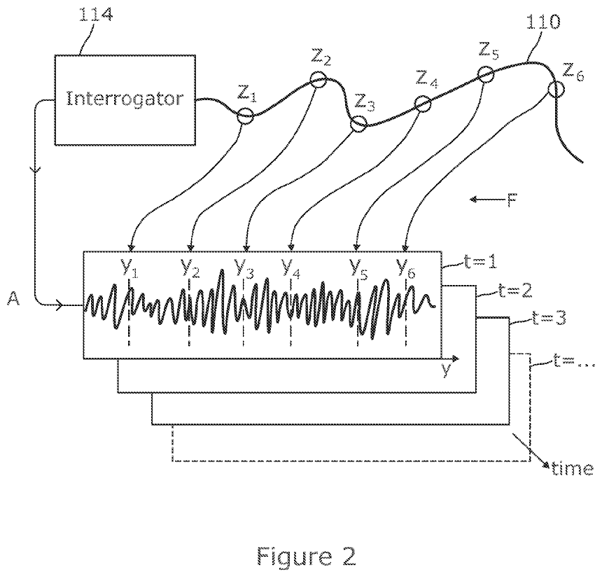

In order to provide suitable subsets of a DAS signal A, a geospatial calibration F is obtained which defines a mapping between portions of a DAS signal A formed using an interrogator 114, and positions or distances along a sensing optical fibre 110 as it follows a path 130 through an environment 112, so that it is known which position along the sensing optical fibre a particular portion of the DAS signal represents. Such a calibration is illustrated in FIG. 2, in which an interrogator 114 forms a DAS signal A by interrogation of a sensing optical fibre 110 in the same manner as described above in respect of FIG. 1.

Along the length of the sensing optical fibre 110 are defined a plurality of positions or distances zin, for example geographic latitude-longitude or other two dimensional or three dimensional positions, or one dimensional distances along the physical path of the fibre from an arbitrary reference point or from the interrogator 114 itself. The DAS signal A is then typically a signal with at least a distance dimension y corresponding to distance along the fibre, and a time dimension t. In this way the DAS signal A represents detected acoustic vibration at many positions along the fibre, each as a function of time. The value of the signal A at each distance and time point could be an intensity, a phase, an acoustic spectrum, or other data as already discussed above.

As shown in FIG. 2, the calibration F may then define a mapping between distances y_{1 n}, and therefore corresponding portions of the signal A, and positions z_{1 n} along the physical sensing optical fibre. For example, in FIG. 2, position z₁ along the fibre maps to a portion of the DAS signal at y₁.

The geospatial calibration F mapping particular portions of the DAS signal A for use in training event models, to particular positions z along the sensing optical fibre, may be obtained in various ways. Sometimes, an installed path 130 of the sensing optical fibre 110 through the environment 112 may be sufficiently well known, for example from existing geographical mapping, and the properties of the interrogator 114 also sufficiently well known, that the calibration can be calculated or derived from that information without further measurements being needed.

However, more often it will be necessary to carry out a deliberate geospatial calibration exercise. Such an exercise is illustrated in FIG. 3. Here, a continuous or intermittent or periodic calibration vibration source 150 is used to generate calibration acoustic signals sequentially at multiple different locations along the sensing optical fibre while using the interrogator 114 to form a distributed acoustic sensing signal A. Conveniently, the calibration acoustic signals may be generated continuously or periodically as the source is moved along the sensing fibre.

The calibration acoustic signals are then detected within the distributed acoustic sensing signal A, for example through timings, acoustic frequency characteristics, or other properties of the calibration acoustic signals. Locations of the calibration vibration source, at about the same times as the calibration acoustic signals are being generated, are then detected independently of, and without using, the DAS signal, for example using a GPS receiver or other location device associated with or collocated with the calibration vibration source. The detected calibration acoustic signals and the separately detected locations are then used to obtain the calibration.

For example, as illustrated in FIG. 3, the calibration vibration source 150 may be moved approximately along the path of the fibre, while monitoring the position z_{c} of the calibration vibration source 150 as a function of time (for example represented using time stamps t_{c} associated with the positions z_{c}) using a calibration position detector 152. At the same time, interrogator 114 forms a DAS signal A as discussed in connection with FIG. 1 above, which contains features which can be automatically recognized by a geospatial calibration unit 154 as caused by the calibration vibration source 150. This automatic recognition can be achieved in various ways such as by bandpass filtering the DAS signal A, calculating the total energy in the result and then thresholding the energy to create an “indicator” showing the locations of the calibration acoustic signals. Alternatively, a machine learning approach could be used in which samples of the calibration acoustic signals are used to train a neural network or similar model to identify calibration acoustic signals.

The position z_{c} as a function of time t_{c}, and the contemporary DAS signal A are both passed to the geospatial calibration unit 154 which associates each of a plurality of portions of the DAS signal A recognized as resulting from the calibration vibration source 150 with a corresponding position z_{c} from the calibration position detector 152, to thereby define and output calibration F, for example as a set of discrete associations between portions of the DAS signal and positions along the fibre, or as one or more corresponding continuous or discrete mapping functions.

As shown in FIG. 3, the calibration vibration source 150 could be provided by a human agent 156 carrying the calibration position detector 152, and thumping periodically on the ground with a tool acting as the calibration vibration source or periodically operating a sounds generation device of characteristic acoustic frequency, or the calibration vibration source could similarly be provided by a wheeled device pushed or pulled by the human agent 154. Alternatively, the vibration source could be implemented using a driven or autonomous vehicle carrying the calibration position detector.

The calibration position detector 152 could be implemented in various ways to generate positions z_{c}, typically also generating the associated time stamps t_{c}. For example it could be implemented using a GPS or other satellite based positioning system; by reference to terrestrial radio transmitters or beacons such as Wi-Fi transmitters, or optical beacons; by reference to existing visual markers such as physical markers sited along the path 130; by dead reckoning for example using one or more accelerometers; or by using combinations of these and/or other techniques.

Note that the interrogator 114, sensing optical fibre 110, path 130 and environment 112 for gathering and preparing a DAS signal for training of event models as illustrated in FIG. 3 may be the same interrogator 14, sensing optical fibre 10, path 30 and environment 12 as that to be used for subsequent operational detection of events of interest according to FIG. 1, or one, more or all of these may different. Clearly, using a sensing optical fibre 110 and interrogator 114 which at least have similar DAS signal response characteristics to events of interest as those to be used in operational detection of events of interest could be advantageous in ensuring that the event models 50 can perform optimally. Similarly, training the event models using DAS signal data obtained from a sensing optical fibre installed in a similar manner, through an environment with similar properties to those to be used operationally, may also permit the event models to perform better operationally in detecting events of interest.

In order to obtain a DAS signal for use in training the event models 50 of FIG. 1, a plurality of events of interest are then implemented, at multiple measured positions zₑ proximal to sensing optical fibre 110, at the same time as interrogator 114 is used to form a DAS signal by interrogating the sensing optical fibre as discussed in respect of FIG. 1 above. The implemented events of interest may be of one or more different categories C to be identified by the event models. In FIG. 3 the events of interest are implemented by agents 164, for example a human agent 164-1 walking approximately along the optical fibre to implement walking events of interest, and an excavator agent 164-2 digging proximally to the optical fibre to implement mechanical digging events of interest.

Similar to the techniques described in respect of obtaining the geospatial calibration, the measured positions zₑ of the implemented events are generated independently of, and without reference to, the contemporary DAS signal, for example using an event position detector located at or proximal to the event of interest. Moreover, the measured positions are preferably also generated at about the same time as the implemented events.

For example, the measured positions may be generated by an event position detector 162 carried by or collocated with the agent implementing the events of interest. The event position detector may for example comprise: a GPS or other satellite based positioning system; a device operating by reference to terrestrial radio transmitters or beacons such as Wi-Fi transmitters, or optical beacons; a device operating by reference to existing visual markers such as physical markers sited along the path 130; a device operating by dead reckoning for example using one or more accelerometers; or by using combinations of these and/or other techniques.

In some embodiments it may be convenient or preferable to generate these measured positions zₑ of the implemented events using the same position detection techniques and/or apparatus as that already used to determine positions z_{c} used in determining the calibration F, so as to provide a greater likelihood of the positions zₑ of the implemented events being accurately related to corresponding portions of the contemporary DAS signal A. For example, both the path 130 and the positions zₑ may be defined using a same satellite or terrestrial based radio positioning system such as GPS, and/or may be expressed using a same coordinate system, such as in latitude and longitude relative to the WGS 84 global datum. In some embodiments for example, the event position detector 162 may be a similar or identical unit to the calibration position detector 152, or the two may actually be the same unit.

Meta data M defining at least a measured position zₑ and time tₑ of an implemented event, and optionally also defining a category C of the implemented event if different categories of events are being implemented in the same scenario, is then passed to the training data segmentor 200, for use in defining one or more training data subsets S of the acoustic vibration signal which are both contemporary with the implemented event, and spatially proximal to the implemented event. In order to ensure that a training data subset S is spatially proximal, and indeed positioned as required relative to the implemented event, the calibration F obtained as described above is used by the training data segmentor 200 in selecting a portion of the acoustic vibration signal A which has the required spatial correspondence to the measured position zₑ of the implemented event. Suitable such spatial correspondences which may be used are described in more detail below.

The training data segmentor 200 then outputs a plurality of such training data subsets S which are passed to the model training unit 300. The model training unit 300 trains, or refines, one or more event models 50 for operational use in the arrangement of FIG. 1 to identify and locate events of interest in a DAS signal A.

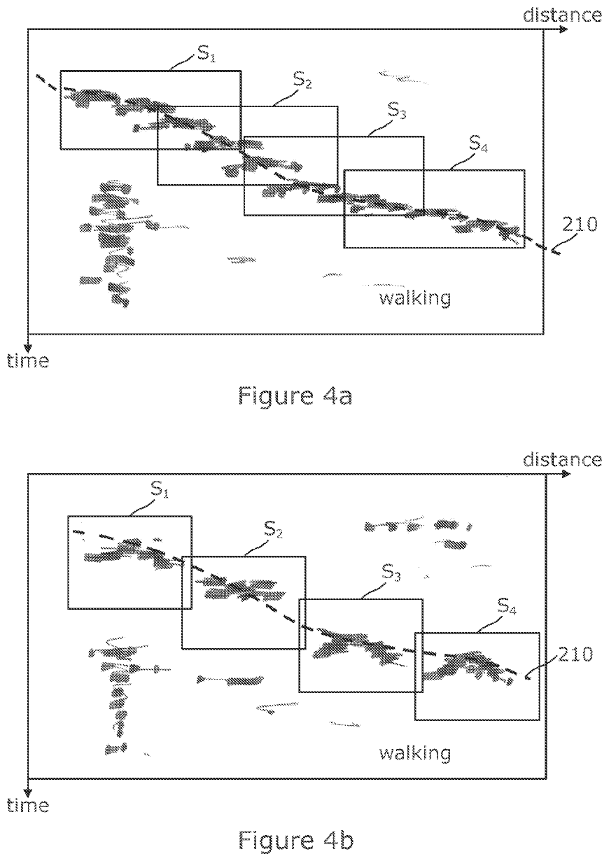

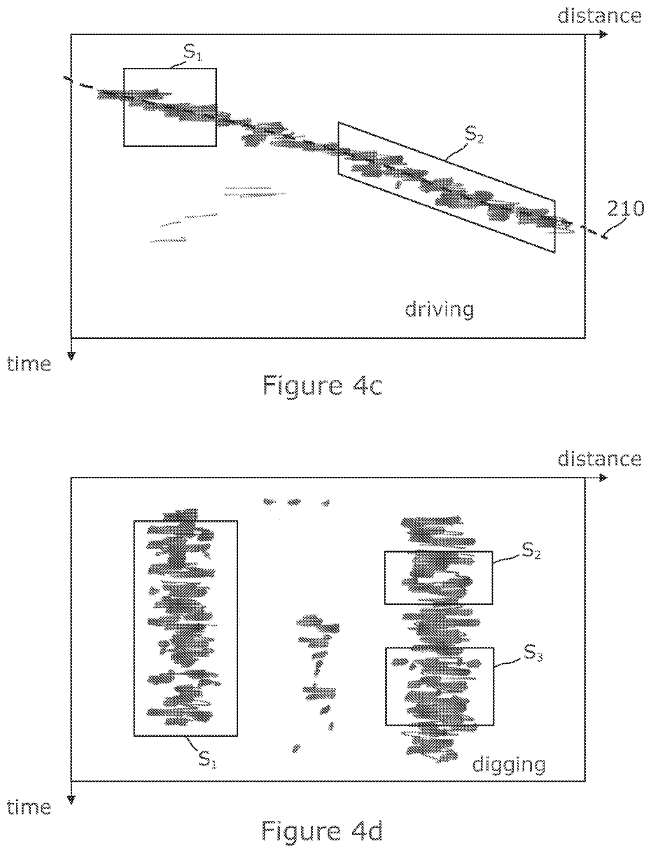

FIGS. 4a to 4d illustrate how the training data segmentor 200 may operate to define one or more training data subsets for training event models. Each of the FIGS. 4a-4d illustrates a DAS signal A which is passed by interrogator 114 to training data segmentor 200 as shown in FIG. 3. The DAS signal is shown with distance as the abscissa and time as the ordinate, and a shading density indicating a property of the DAS signal at each distance and time point, for example a property such as total DAS signal power at that point.

The training data segmentor also receives metadata M; (C, Zₑ, tₑ) from a position detector 162 associated each agent 164 implementing events of interest along the sensing optical fibre. If just one category of event is being implemented in a particular scenario or at a particular time then the meta data need not include a category C, and the meta data could omit the timestamp tₑ with this instead being generated at the training data segmentor or elsewhere.

In FIG. 4a, a human agent 164-1 walks along the sensing optical fibre. A physical trajectory 210 of the human agent along the sensing optical fibre is known from the measure positions zₑ and timestamps in the metadata, and the measured positions are translated to a distance position in the DAS data using the calibration F. This enables the training data segmentor to determine the trajectory 210 of the human agent 164-1 within the space of the DAS data as shown in FIG. 4a.

The training data segmentor 200 then defines suitable training data subsets S1-S4 of the DAS signal data which encompass the acoustic signal from the implemented event of interest to an extent suitable for training the event models. In FIG. 4a the training data segmentor simply selects each subset to be of a suitable length of time corresponding to a few walking steps, for example 4 seconds, without regard to the exact positions of the waling steps within the DAS signal data. In FIG. 4a also, a series of subsets are defined which overlap in time by around 10-50%, although the subsets could instead be defined which are proximate or touching but which do not overlap.

The size of each training data subset may be adjusted depending for example on the expected accuracy of the geospatial calibration F in enabling the training data segmentor to accurately anticipate the position of an acoustic signal in the DAS signal relating to a particular implemented event. For the purposes of training event models, smaller subsets which contain little more than the relevant acoustic signal for training are desirable, but where this anticipation is less accurate the size of each training data subset may be increased. In FIG. 4a each training data subset may be about 4 seconds in duration and 6 meters in length, but could be increased to say 4 seconds in duration and 12 meters in length where the expected positional accuracy is less.

In FIG. 4b the training data segmentor 200 defines suitable training data subsets S1-S4 each of which corresponds to a single walking step or several particular walking steps. Here, determination of the actual step positions along the trajectory 210 is carried out either by the training data segmentor, or using further metadata received from the event position detector 162 carried by the human agent 163-1 which defines the position of discrete steps. For example, the training data segmentor could carry out a total acoustic power analysis along the trajectory, seek a periodic variation in that total acoustic power which matches a typical walking rate, and allocate portions of the DAS signal along the trajectory according to the periodic variation.

In FIGS. 4a and 4b the training data subsets are conveniently rectangular in shape with respect to the time and distance axes of the DAS signal. However, this not need be the case. In FIG. 4c for example, an acoustic signal arising from a vehicle driving approximately along the sensing optical fibre is shown. A first example training data subset

S1 then defines a rectangle of the data for example around 10 seconds in duration and 30 meters in length. However, this rectangular form may lead to excessive portions of the subset being devoid of useful signal for training purposes. To this end, a second example training data subset S2 takes a parallelogram form which more closely follows the trajectory 210 known from the measured positions zₑ of the metadata and the calibration F.

FIG. 4d shows how the training data segmentor 200 may define training data subsets in respect of implemented events which are essentially static. The subset S1 represents mechanical digging by a mechanical excavator agent 164-2, and the subsets S2 and S3 represent manual digging by a human agent 164-1. These subsets will typically be defined so as to be rectangular, with a distance length of, say, 2 to 10 meters, and durations in time of perhaps 10 to 100 seconds.

Because the calibration F enables the training data segmentor to automatically define training data subsets with reasonable accuracy using the metadata from a relevant event position detector, the described methods and apparatus allow the training data segmentor to carry out its role with little or no human intervention or checking before the training data subsets are used for training the event models as discussed below.

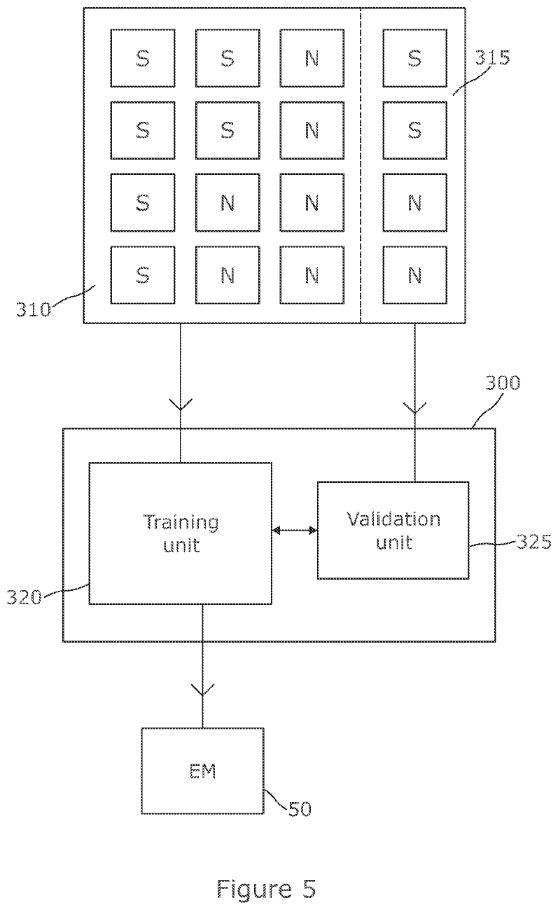

Further details of how the event model training unit 300 may be implemented are shown in FIG. 5. A large number (for example a few hundred or few thousand) of training data subsets S of DAS signal data, each of which contains the acoustic signal of an event of interest, and defined using the training data segmentor 200 as discussed above, and a large number of similar but null training data subsets N which do not contain the acoustic signal of an event of interest, but which none-the-less do contain acoustic signals of broadly similar magnitude also extracted from suitable DAS signal data, are collected together to form a training data set 310. From this training data set a portion, for example about 20%, is extracted and kept separate as a validation data set 315.

A training unit 320 of the event model training unit 300 then trains an event model to categorize the training data set 310 into those subsets S which represent events of interest, and those subsets N which do not. To avoid overtraining, a validation unit 325 periodically applies the partly trained event model to the validation data set 315 to ensure that the trained event models are able to adequately categorize both the training data set and the validation data set. Once the event model is deemed adequately trained, it can be output as a trained model for use operationally as illustrated in FIG. 1.

If a particular training data set contains subsets S of DAS signal data relating to only one category of event of interest, such as walking, then a single event model 50 may be trained using that training data, in order to categorize operational DAS signal data according to whether that event of interest is present or not. Other event models may be trained in a similar manner if required to identify different categories of events of interest. However, it may be desirable to provide a training data set which contains subsets each of which represents one of multiple different categories of events of interest such as walking, manual digging, mechanical digging, vehicle driving and so forth, in which case a single event model may be trained as a multiclass model to identify and correctly categorize multiple categories of events of interest.

The event models 50 may be implemented using a variety of statistical and/or artificial intelligence or automated machine learning tools. For example the TensorRT software development kit (see https: i/developer.nvidia.com/tensorrt) may be used to train event models which can then be implemented on NVidia GPU processing boards to enable very fast processing of DAS signal data. Devices such as the NVidia Xavier contain neural network specific hardware that provide high levels of acceleration of neural network operations. Event models deployed operationally in this way are able to identify events of interest essentially in real time as illustrated in FIG. 1 without heavy use of multiple CPUs or other larger scale computer resources.

However, other automated machine learning tools which may be used to train and implement the event models include the H2O tool set (for example see www.h2o.ai) either binary or multi-class classification, and the open source Python toolkit TPOT (see http://epistasislab.gilhub.io/tpot/) which uses genetic programming to provide an optimized pipeline for a particular machine learning problem.

Various aspects of the apparatus and methods described above may be implemented using computer software executing on one or more suitable computer systems. This enables the described data processing techniques to be implemented automatically and without human intervention. In particular, the event monitor 40 of FIG. 1 including the trained event models 50, and the geospatial calibration unit 154, the training data segmentor 200, and the model training unit 300 may be implemented in software in such a manner using one or more computer systems which may collocated or in different locations. Each such computer system may typically each comprise one or more computer processors or microprocessors arranged to execute the computer program code, the processors being coupled to suitable volatile and/or non-volatile memory for storing the computer program code and associated data for example including distributed acoustic sensing signals, the training data subsets, and the trained event models.

Such computer systems may also typically be provided with suitable input and output peripherals such as screen, keyboard and mouse, or may be implemented as servers typically not connected to any such peripherals, but controllable over suitable data network connections.

By way of demonstration, the inventors have implemented the invention in various ways. In one demonstration, an interrogator 114 as illustrated in FIG. 3 which was time synchronized to a GPS signal was used to record a distributed acoustic sensing signal at the same time as an engineer walked along the length of a buried sensing optical fibre. The engineer carried a Garmin GLO2 GPS device connected to an Apple iPad logging a GPX track containing latitude, longitude and time. A calibration was obtained by the engineer tapping on the ground near the fibre to form a calibration acoustic signal, at locations recorded in the GPX track. The calibration acoustic signals were then also identified within the recorded distributed acoustic sensing signals, and a calibration mapping was formed by associating each GPX location with the related calibration acoustic signal seen in the distributed acoustic sensing signal.

An engineer then again walked a large number of shorter lengths of the sensing optical fibre to generate multiple events of interest of the walking category. while carrying the same Garmin GLO2 GPS device, and logging the walking events of interest within the recorded GPX tracks in order to measure the positions of the implemented events of interest. The distributed acoustic sensing data recorded by the interrogator 114 at the same time was then automatically processed to define multiple training data subsets selected by using the GPS measured positions of the walking events, and the previously obtained calibration mapping to translate the measured positions to identify the correct portions of the distributed acoustic sensing signal which contained the acoustic signal of the walking events.

The multiple training data subsets were then used without further editing or modification to train a machine learning model which was used to successfully and automatically identify multiple instances of an engineer walking close to the sensing optical fibre in subsequently acquired distributed acoustic sensing data.

Although specific embodiments of the invention have been described with reference to the drawings, the skilled person will be aware that variations and modifications may be applied to these embodiments without departing from the scope of the invention defined in the claims.

For example, although embodiments of the invention have largely been described within the context of distributed acoustic sensing using suitable sensing optical fibres, using an essentially one dimensional sensing optical fibre following a path through an environment, it may also be implemented using other sensing technologies for example using a sensing optical fibre comprising an array of Bragg gratings, using an array of discrete microphone devices or other acoustic sensors, and in other ways. Such arrays need not comprise only a one dimensional array but can potentially provide a network or array of acoustic detection locations which is one, two or three dimensional in nature.

Although the invention and embodiments have largely been described in terms of acoustic sensing, acoustic vibration, and acoustic signals, embodiments may more generally use distributed optical fibre sensing to form distributed optical fibre sensor signals representing disturbance or disturbances, and in particular physical disturbances, along one or more sensing optical fibres. Embodiments may then train and/or use event models to detect the events of interest using such distributed optical fibre sensor signals.

1. A method of training one or more event models for use in identifying, from a distributed acoustic sensing signal representing acoustic vibration at positions along a sensing optical fibre, events of interest proximal to the sensing optical fibre, the method comprising:
providing a distributed acoustic sensor arranged to form a distributed acoustic sensing signal;
obtaining a calibration defining a mapping between the distributed acoustic sensing signal and positions along the sensing optical fibre;
implementing events of interest of one or more different event categories, at measured positions along the sensing optical fibre;
forming the distributed acoustic sensing signal during the implemented events of interest;
for each implemented event of interest, defining one or more training data subsets of the distributed acoustic sensing signal which are contemporary with the implemented event, and spatially positioned within the signal using the measured positions and the calibration so as to include the implemented event; and
using the training data subsets to train one or more event models to detect the events of interest.

2. The method of claim 1 wherein the event models are trained to distinguish between events of two or more event categories.

3. The method of claim 1 wherein the one or more different event categories comprise one or more of: a person walking, manual digging, mechanical digging, and a vehicle driving.

4. The method of claim 1 further comprising:
using a calibration vibration source to generate calibration acoustic signals sequentially at multiple different locations along the sensing optical fibre while using the distributed acoustic sensor to form a distributed acoustic sensing signal;
detecting the calibration acoustic signals within the distributed acoustic sensing signal;
separately detecting locations of the calibration vibration source as the calibration acoustic signals are being generated; and
using the detected calibration acoustic signals with the separately detected locations to obtain the calibration. vi (Original) The method of claim 4 wherein separately detecting locations of the calibration vibration source as the calibration acoustic signals are being generated comprises using a calibration position detector collocated with the calibration vibration source to detect the locations.

6. The method of claim 5 wherein the calibration position detector is a satellite based navigation system detector such as a GPS receiver.

7. The method of claim 1 wherein implementing events of interest of one or more different event categories, at measured positions along the sensing optical fibre, comprises using one or more agents to implement the events of interest, and measuring the positions of the implemented events using an event position detector collocated with each such agent.

8. The method of claim 7 comprising measuring the positions along the sensing optical fibre at the same times as the implementation of the events of interest.

9. The method of claim 7 wherein the event position detectors are satellite based navigation system detectors.

10. The method of claim 1 further comprising:
receiving a distributed acoustic sensing signal from the same or a different distributed acoustic sensor, and detecting one or more events of interest using the one or more trained event models.

11. Apparatus for training one or more event models for use in identifying, from a distributed acoustic sensing signal representing acoustic vibration at positions along a sensing optical fibre, events of interest proximal to the sensing optical fibre, the apparatus comprising:
a geospatial calibration unit arranged to obtain a calibration which defines a mapping between the distributed acoustic sensing signal and positions along the sensing optical fibre;
a training data segmentor arranged to receive the distributed acoustic sensing signal formed during implementation of events of interest of one or more different event categories, at measured positions along the sensing optical fibre, and for each implemented event of interest, to define one or more training data subsets of the distributed acoustic sensing signal which are contemporary with the implemented event, and which are spatially positioned within the signal using the measured positions and the calibration so to include the implemented event; and
a model training unit arranged to use the training data subsets to train one or more event models to detect the events of interest.

12. The apparatus of claim 11 further comprising a calibration vibration source for generating calibration acoustic signals sequentially at multiple different locations along the sensing optical fibre, and a calibration position detector collocated with the calibration vibration source for detecting locations of the calibration vibration source as it generates calibration acoustic signals.

13. The apparatus of claim 12 wherein the geospatial calibration unit is arranged to obtain the calibration by detecting the calibration acoustic signals in the distributed acoustic sensing signal, and combining the detected acoustic calibration signals with the detected locations of the calibration vibration source.

14. The apparatus of claim 13 wherein the calibration position detector is a satellite based navigation system detector such as a GPS receiver.

15. The apparatus of claim 11 further comprising one or more event position detectors collocated with one or more agents implementing the events of interest, wherein the positions of the implemented events of interest are measured using the one or more event position detectors.

16. The apparatus of claim 15 wherein the event position detectors are satellite based navigation system detectors.

17. (canceled)

18. One or more non-transitory computer readable media comprising computer program code arranged to train one or more event models for use in identifying, from a distributed acoustic sensing signal representing acoustic vibration at positions along a sensing optical fibre, events of interest proximal to the sensing optical fibre, the computer program code when executed by a processor being arranged to:
determine a calibration which defines a mapping between the distributed acoustic sensing signal and positions along the sensing optical fibre;
receive the distributed acoustic sensing signal formed during implementation of events of interest of one or more different event categories, and measured positions of the implemented events of interest along the sensing optical fibre, and for each implemented event of interest, to define one or more training data subsets of the distributed acoustic sensing signal which are contemporary with the implemented event, and which are spatially positioned within the signal using the measured positions and the calibration so to include the implemented event; and
use the training data subsets to train one or more event models to detect the events of interest.
